(19) United States
(12) Patent Application Publication
(10) Pub. No.: US 2005/0036620 A1
(43) Pub. Date: Feb. 17, 2005

(54) Encryption of radio frequency identification tags

(76) Inventors: Martin S. Casden, Calabasas, CA (US); Randy Watkins, Chatsworth, CA (US)

Correspondence Address: Natan Epstein, Esq.;Law Offices of Natan Epstein, 9th Floor, 11377 West Olympic Boulevard, Los Angeles, CA, 90064, US

(21) Appl. No.: 10/626,054

(22) Filed: Jul. 23, 2003

(51) Int. Cl. H04Q 5/22; G08B 5/22

(52) U.S. Cl. 380/259; 340/825.49

(57) ABSTRACT

A method for encrypting and decrypting user data stored on identification tags, such as RFID tags, of the type having a tag identification code unique to each tag. An encryption/decryption key unique to each tag is based in part or in whole on the tag identification code of each tag, and the unique key is used to encrypt data for storage on the corresponding tag and to decrypt encrypted user data stored on the tag.

### BACKGROUND OF THE INVENTION

1. Field of the Invention

This invention relates generally to the field of identification tags encoded with machine readable data, such as radio frequency identification (RFID) tags, and more particularly concerns encryption of data stored on such tags.

2. State of the Prior Art

Electronic identification tags are in wide use in security, access control and article tracking systems, among still other applications. Such tags are commercially available from a variety of vendors, such as Texas Instruments, in a range of physical formats and data storage capabilities.

Electronic identification tags are made with read only capability and with read/write capability. The latter can be written to by suitably configured tag readers, which can read as well as write data to the tags. In either case, each tag has a data storage or memory which is programmable with user data associated with a particular person or article to be identified by the particular tag. Typical user data may include, for example, a personal identification number (PIN) assigned in to a person and possibly other data appropriate to a particular application, such as levels of permitted access to a building or system. The user data may be 64 bits in length, for example, in the case of an identification tag. Larger data capacities are provided in tags intended for applications such as contactless RFID payment systems.

Electronic ID tags are made to conform to industry standards which specify various operating parameters and characteristics of the tags so as to render tags sold by different vendors compatible with tag readers configured to a particular standard. Certain electronic identification tags, such as those complying with ISO 15693 and ISO 14443 standards among many others, have, in addition to the programmable user data storage, a permanent factory programmed unique identification (UID) code which is unique to each tag. This unique tag identifier is typically a binary string of 32 to 64 bits in length, and is not changeable.

### SUMMARY OF THE INVENTION

A method is disclosed for encrypting and decrypting user data stored on identification tags of the type having a unique identification (UID) code on each tag, comprising the steps of generating a key based in part or in whole on the UID code of a tag, encrypting user data with the key to derive encrypted user data for storage on the tag, and decrypting the encrypted user data read from the tag with the key, such that a key unique to each tag is generated for encryption and decryption of user data stored on each tag. The identification tags may be radio frequency identification (RFID) tags.

The invention is also a method of encrypting identification tags of the type having a data storage for storing a fixed tag UID unique to each of the tags and variable user data, the tag UID and user data being readable by a tag reader. The method comprises the steps of providing an identification tag having a permanent UID stored thereon, providing an encryption engine operative for encrypting user data with an encryption key, entering the tag UID to provide part or all of the encryption key, entering user data for encryption by the engine, encrypting the user data with the encryption key to derive encrypted user data, and storing the encrypted user data in the data storage of the identification tag. The tag may be an RFID tag and the data storage may be readable by an RFID reader.

The encryption engine may include an encryption algorithm running on a digital processor platform enabled for reading and writing to the data storage of the identification tag. The digital processor platform may be operatively associated with an RFID reader for reading and writing to the data storage of the tag. The encryption algorithm may be any suitable encryption algorithm, for example a DES encryption algorithm.

The encryption key may be in the form of a final key based on a combination of the tag UID and a private key. For example, the final key may be derived by XORing the private key with the tag UID.

The invention is also a method of decrypting user data encrypted as by the preceding encryption method and stored on an encrypted identification tag. The decryption method has the steps of providing a decryption engine operative for decrypting the encrypted user data with a decryption key, presenting an encrypted identification tag for reading, reading the tag UID and the encrypted user data stored on the presented encrypted identification tag, providing the read tag UID to the decryption engine for deriving the decryption key, providing the encrypted user data to the decryption engine for decryption with the decryption key; and decrypting the encrypted user data with the decryption engine to derive decrypted user data.

The decryption engine may include a decryption algorithm running on a digital processor platform enabled for reading and writing to the encrypted identification tag. The digital processor platform may be operatively associated with an RFID reader for reading and writing to the encrypted identification tag. The decryption algorithm may be any suitable decryption algorithm such as a DES decryption algorithm.

The decryption key may be a final key based on a combination of the tag UID read from the presented tag and a private key. For example, the final key may be derived by XORing the private key with the read tag UID.

### BRIEF DESCRIPTION OF THE DRAWINGS

FIG. 1 is a block diagram of the user data encryption process according to this invention; and

FIG. 2 is a block diagram of the user data decryption process according to this invention.

### DETAILED DESCRIPTION OF THE PREFERRED EMBODIMENT

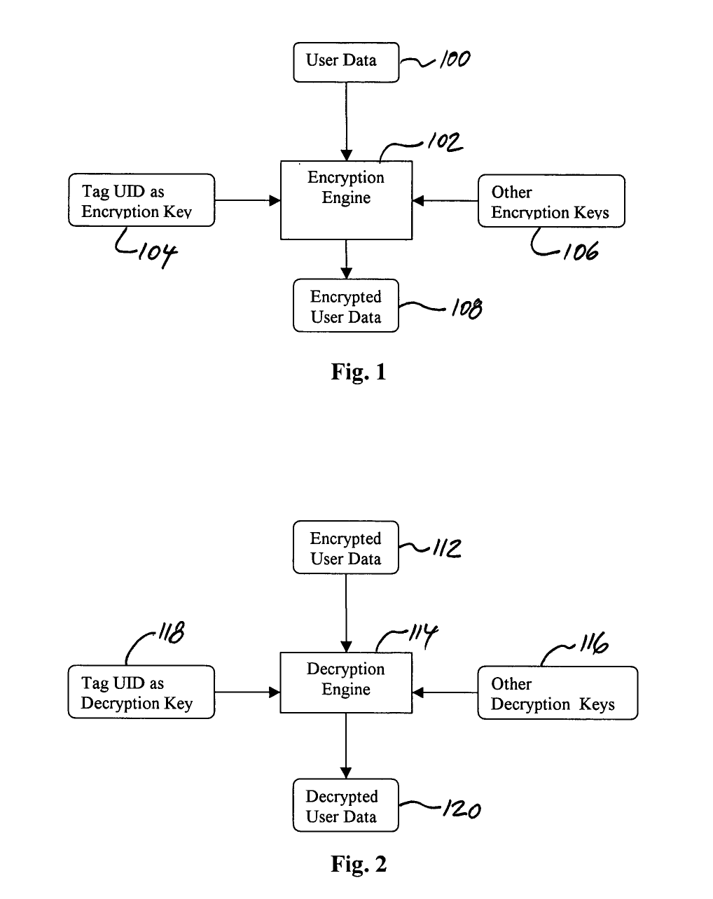

With reference to FIG. 1 of the accompanying drawings, user data 100 is encrypted for storage in encrypted form on electronically readable identification cards such as radio frequency identification (RFID) tags. Such tags are used in different formats, for example, by embedding in electronic key cards which may be printed with user identification, including user name and likeness. The tag is written with user data which identifies the authorized tag user to the electronic tag reader. Electronic user data 100, such as a PIN number, is encrypted by means of an encryption engine 102 which applies an encryption algorithm to a user data input. The encryption algorithm operates with an encryption key which is based in whole or in part on a unique tag UID 104 stored at the factory on each tag by the tag manufacturer and which cannot be subsequently altered.

The method of this invention is performed on identification tags, such as RFID tags readable by appropriate RFID readers. Encryption engine 102 is operative for encrypting user data 100 supplied, for example, by an administrator of the system employing the identification tags. The encryption engine 102 is configured for operating on the user data 100 with an encryption key. The encryption key may consist of the UID 104 alone, or of a composite encryption key derived by combining the UID with another key component 106, such as a private key known only to the system administration. For example, the final key may be derived by XORing a private key 106 with the tag UID 104.

The tag UID 104 of the particular tag to which the encrypted user data is to be written is provided to the encryption engine 102. This normally involves reading the UID of each tag to which user data is to be written, as the UID by definition is different on each tag. The unencrypted user data 100 is provided for encryption to the encryption engine 102, and the user data 100 is encrypted with the encryption key 104, 106 to derive encrypted user data 108. The encrypted user data 108 may then be stored, i.e. written to, the data storage or memory of the particular identification tag.

The encryption engine 102 has an encryption algorithm running on a digital processor platform enabled for reading and writing to the data storage of the identification tag. For example, the encryption engine 102 may be in the form of firmware executed by a microprocessor and related hardware in an RFID reader configured for reading and writing to the data storage of the tag. The encryption algorithm may be any suitable encryption algorithm, such as a DES, Triple DES or other encryption algorithm.

The encryption engine can operate to perform an encryption algorithm as simple as XORing a “key” with the user data to be encrypted, or as complex as applying the standard DES, Triple DES, or still other encryption algorithms to encrypt the data using a “key”. For purposes of example only, the following Table I illustrates UID based encryption using the simple XOR method.

TABLE I
Encryption Example Tag #1

| | |
|---|---|
| User Data before encryption | 0000000012345678 |
| RFID Tag UID | E00700000681AC64 |
| Private Key | 0F1E2C3B4A596877 |
| Final Key (Private Key XORed with Tag UID) | EF192C3B4CD8C413 |
| Encrypted User Data (User Data XORed | EF192C3B5EEC926B |
| with Final Key) | |

As explained previously, all ISO 15693 and ISO 14443 (and many other tags) contain a unique identifier from 32 to 64 bits in length, the UID, which is factory programmed and is not changeable. In the examples of Table 1 the encryption engine XORs 64 bits of user data with a 64 bit encryption key. In these examples the encryption key is a composite key designated the Final key, derived using a 64 bit Private key XORed with the 64 bit RFID tag UID. The data and keys are shown in hexadecimal form for convenience, although these factors are encoded in binary form on the tag.

Encryption Example Tag #2

| | |
|---|---|
| User Data before encryption | 0000000012345678 |
| RFID Tag UID | E0070375AC349D25 |
| Private Key | 0F1E2C3B4A596877 |
| Final Key (Private Key XORed with Tag UID) | EF192F4EE66DF552 |
| Encrypted User Data (User Data XORed | EF192F4EF459A329 |
| with Final Key) | |

In Encryption Example Tag #2 the same User Data as in Encryption Example Tag #1 is written to a different RFID Tag which has a different UID. The UID is again XORed with the same Private Key to derive a new Final Key which in Example 2 is different from the Final Key of Example 1. The encryption algorithm, in this case the XOR operation, is applied to the User Data using the new Final Key to derive the Encrypted User Data. It will be appreciated that the Encrypted User Data for the two different RFID tags is different because of the different tag UIDs, even though the same User Data and Private Key were used with the same encoding algorithm.

The tags written with user data encrypted as by the method of TABLE 1 are normally intended to be read by a tag reader such as an RFID reader, and the original unencrypted user data is recovered from the tag by a user data decryption process. The decryption process is illustrated in FIG. 2. The tag reader or other system capable of reading the Encrypted user data 112 on a presented tag is provided with an appropriate decryption engine 114 including suitable data processing hardware, such as a reader microprocessor and associated hardware, and decryption firmware or software running on the data processing hardware. If the user data was encrypted with a composite key the decryption engine is provided with the constant key component 116, such as the Private Key of this example. The Private Key may be stored in the tag reader or otherwise provided to the decryption engine 114. The tag UID 118 of the presented tag is read and entered in the decryption algorithm executed by decryption engine 114. The tag UID 118 is combined, if a combination key is used, with other decryption key 116 for deriving a final decryption key. The decryption engine applies the final decryption key to the decryption algorithm and operates on the Encrypted User Data to derive the Unencrypted User Data 120. If the Decryption key used in the decryption process of FIG. 2 is the same as the encryption key in the encryption process of FIG. 1, the Decrypted User Data 120 will be the same as the original, unencrypted User Data 100.

A simple example of the decryption process is shown in Table II below as Decryption Example Tag #1, in which the Encrypted User Data of Encryption Example Tag #1 above is decrypted to recover the original unencrypted User Data.

TABLE II
Decryption Example Tag #1

| | |
|---|---|
| Private Key | 0F1E2C3B4A596877 |
| RFID Tag UID | E00700000681AC64 |
| Final Key (Constant Key XORed with Tag UID) | EF192C3B4CD8C413 |
| Encrypted User Data | EF192C3B5EEC926B |
| Decrypted User Data (Encrypted User Data | 0000000012345678 |
| XORed with Final Key) | |

In this decryption example, Tag #1 of the first encryption example in TABLE I with Encrypted User Data stored in the tag's memory is presented for reading by the tag reader. The tag reader reads the tag UID of Tag #1 and also reads the Encrypted User Data stored on the presented tag. The read Tag UID is presented as an input to the decryption engine which under control of the decryption algorithm firmware or software combines the Private Key with the read tag UID to derive the Final Key. In this example the combination is by XORing the Private Key with the tag UID. The Final Key is used as the decryption key in this example. The Encrypted User Data is provided to the decryption engine for decryption with the decryption key. The decryption algorithm running on the decryption engine performs the decryption, in this example by XORing the encrypted user data with the Final Key to derive the Decrypted User Data. The Decrypted User Data in TABLE II is the same as the User Data before encryption in Encryption Example Tag #1 of TABLE I.

In the foregoing examples the encryption key and decryption key is the same composite Final Key derived by combining each tag UID, which is different in each tag, with a constant Private Key, for greater security. Alternatively, the tag UID alone could be used as the encryption/decryption key. It should be understood that more complex derivations of the encryption/decryption key are within the scope of the invention, as are more complex encoding/decoding algorithms than those shown in the preceding examples.

The use of a tag UID as an encryption key which changes from tag to tag frustrates unauthorized duplication of tags. If the encrypted user data from a first tag is copied to a second tag, the tag reader executing the decryption algorithm will attempt to use the tag UID of the second tag in its decryption algorithm. Since the user data was encoded with the tag UID of the first tag as part of the encryption key, the encrypted user data cannot be successfully decrypted using the different tag UID of the second tag. As a result, the unauthorized duplicate second tag can be distinguished from the authorized original tag by the tag reader.

While a preferred embodiment of the invention has been described for purposes of clarity and example, it should be understood that changes, modifications and substitutions to the described embodiment will be apparent to those having ordinary skill in the art, without thereby departing from the scope of this invention, which is defined by the following claims.

1. A method of encrypting identification tags of the type having a data storage for storing a fixed tag UID unique to each of said tags and variable user data, said tag UID and said user data being readable by a tag reader, said method comprising the steps of:
providing an identification tag having a permanent UID stored thereon;
providing an encryption engine operative for encrypting user data with an encryption key;
entering said UID to provide part or all of said encryption key;
entering user data for encryption by said engine;
encrypting said user data with said encryption key to derive encrypted user data; and
storing said encrypted user data in said data storage of said identification tag.

2. The method of claim 1 wherein said tag is an RFID tag and said data storage is readable by an RFID reader.

3. The method of claim 1 wherein said encryption engine comprises an encryption algorithm running on a digital processor platform enabled for reading and writing to said data storage.

4. The method of claim 3 wherein said digital processor platform is operatively associated with an RFID reader for reading and writing to said data storage.

5. The method of claim 3 wherein said encryption algorithm is a DES encryption algorithm.

6. The method of claim 1 wherein said encryption key is a final key based on a combination of said tag UID and a private key.

7. The method of claim 6 wherein said final key is derived by XORing said private key with said tag UID.

8. A method of decrypting encrypted user data stored on an encrypted identification tag, comprising the steps of:
providing a decryption engine operative for decrypting said encrypted user data with an encryption key;
presenting an encrypted identification tag for reading;
reading said tag UID and said encrypted user data stored on said encrypted identification tag;
providing said tag UID to said decryption engine for deriving said encryption key;
providing said encrypted user data to said decryption engine for decryption with said encryption key; and
decrypting said encrypted user data with said decryption engine to derive decrypted user data.

9. The method of claim 8 wherein said encrypted identification tag is an RFID tag and said tag is readable by an RFID reader.

10. The method of claim 8 wherein said decryption engine comprises a decryption algorithm running on a digital processor platform enabled for reading and writing to said encrypted identification tag.

11. The method of claim 10 wherein said digital processor platform is operatively associated with an RFID reader for reading and writing to said encrypted identification tag.

12. The method of claim 10 wherein said decryption algorithm is a DES decryption algorithm.

13. The method of claim 8 wherein said encryption key is a final key based on a combination of said tag UID and a private key.

14. The method of claim 13 wherein said final key is derived by XORing said private key with said tag UID.

15. A method for encrypting and decrypting user data stored on identification tags of the type having a UID code on each tag, comprising the steps of generating a key based in part or in whole on said UID code of one said tag, encrypting said user data with said key to derive encrypted user data for storage on said one tag, and decrypting encrypted user data read from said one tag with said key, such that a unique key is generated for encryption and decryption of user data on each tag.

16. The method of claim 15 wherein said identification tags are RFID tags.
